(19) United States
(12) Patent Application Publication
(10) Pub. No.: US 2010/0023888 A1
(43) Pub. Date: Jan. 28, 2010

(54) METHOD AND APPARATUS FOR CONTROLLING FOCUS OF APPLICATION

(75) Inventor: Dong-Hyun Song, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/388,893

(22) Filed: Feb. 19, 2009

(30) Foreign Application Priority Data
Jul. 22, 2008 (KR) 10-2008-0071216

(51) Int. Cl. G06F 3/048

(52) U.S. Cl. 715/802

(57) ABSTRACT

Provided are a method and apparatus for controlling a focus of an application so that the focus is not compulsorily moved in a web browser. The method includes the operations of performing focus movement caused by a user input event in the application, detecting predetermined focus attribute information when focus movement caused by contents is requested while the user input event is processed, and determining the focus movement caused by contents according to the predetermined focus attribute information.

### CROSS-REFERENCE TO RELATED PATENT APPLICATION

This application claims priority from Korean Patent Application No. 10-2008-0071216, filed on Jul. 22, 2008, in the Korean Intellectual Property Office, the disclosure of which is incorporated herein in its entirety by reference.

### BACKGROUND OF THE INVENTION

1. Field of the Invention

Applicants and methods consistent with the present invention relate to controlling a focus of an application, and more particularly, to controlling a focus of an application so that the focus is not compulsorily moved in a web browser.

2. Description of the Related Art

In general, web browsers, such as Internet Explorer or Netscape, communicate with web servers primarily using a hypertext transfer protocol (HTTP) so as to fetch webpages. That is, web browsers not only fetch webpages but also transmit information to web servers by using an HTTP.

A file format for a web page is usually generated by using hypertext markup language (HTML). However, in addition to HTML, most web browsers support a variety of image formats, such as Joint Photographic Experts Group (JPEG), Portable Network Graphics (PNG) and Graphics Interchange Format (GIF) image formats, and can be extended to support more functions through the use of plugins. The combination of the HTTP “content type” and the Uniform Resource Locator (URL) protocol specification allows web page designers to embed images, animations, video, sound, and streaming media into a web page, or to make them accessible through the web page.

Such web browsers perform focus movement to index an anchor point. Here, a new mechanism is required to perform the focus movement according to a user's intention.

### SUMMARY OF THE INVENTION

The present invention provides a method and apparatus for controlling a focus of an application so that the focus is not compulsorily moved in a web browser.

According to an aspect of the present invention, there is provided a method of controlling a focus of an application, the method including the operations of performing focus movement caused by a user input event in the application; detecting predetermined focus attribute information when focus movement caused by contents is requested while the user input event is processed; and determining the focus movement caused by contents according to the predetermined focus attribute information.

According to another aspect of the present invention, there is provided an apparatus for controlling a focus, the apparatus including an input unit generating a user input event; a display unit displaying a focus area on a web browser; and a control unit performing focus movement caused by the user input event in the web browser, detecting predetermined focus attribute information when focus movement caused by contents is requested while the user input event is processed, and determining the focus movement caused by contents according to the predetermined focus attribute information.

### BRIEF DESCRIPTION OF THE DRAWINGS

The above and other aspects of the present invention will become more apparent by describing in detail exemplary embodiments thereof with reference to the attached drawings in which:

FIG. 1 is a conceptual diagram for describing focus movement in a web browser, according to exemplary embodiments of the present invention;

FIG. 2 is a block diagram of a multimedia apparatus for implementing a method of controlling a focus of an application, according to an exemplary embodiment of the present invention;

FIG. 3 is a flowchart of a method of controlling a focus of an application, according to an exemplary embodiment of the present invention; and

FIG. 4 is a flowchart of a method of controlling a focus of an application, according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

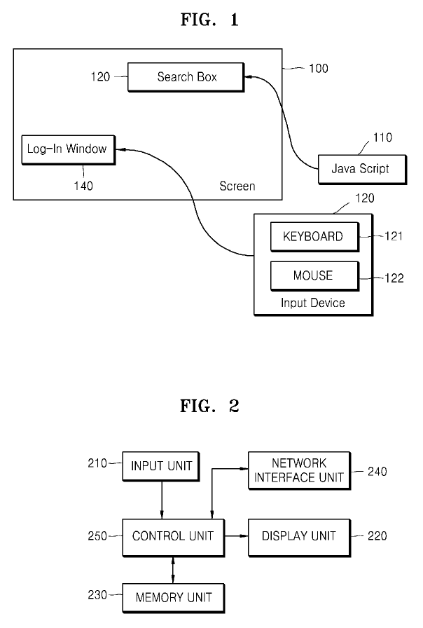

FIG. 1 is a conceptual diagram for describing focus movement in a web browser, according to exemplary embodiments of the present invention.

The focus movement in the web browser occurs due to a user input event with an input device 120, such as a mouse 122 or a keyboard 121, or with contents such as JavaScript 110. For example, when the user clicks a search box 120 on a screen 100 of a Web search engine by using the mouse 122 so as to input a search keyword, or when the user clicks a log-in window 140 so as to log-in to a website, a focus of the web browser moves to corresponding windows that are the search box 120 and the log-in window 140.

However, when webpages are loaded on a web browser from a certain Web search engine, a focus may be compulsorily moved to the search box 120 due to the JavaScript 110.

In the case where elements, which may move a focus at a certain time, simultaneously occur, the focus movement may be performed regardless of a user's intention. For example, assuming that the focus is compulsorily moved from the log-in window 140 to the search box 120 due to JavaScript when webpages are all loaded on a web browser from a Web search engine. In this regard, a user attempts to log-in to the Web search engine when the log-in window 140 pops up while the loading of the webpages is delayed due to a network problem. At this time, if the loading of the webpages is complete when the user still inputs an identification (ID) and a password, the focus moves from the log-in window 140 to the search box 120, and the user unintentionally inputs the ID and the password on the search box 120.

In this manner, while a user inputs an ID and a password to log into an Internet portal site, a focus may move to a search box such that the password of the user may be revealed in the search box.

Exemplary embodiments of the present invention define a new attribute in hypertext markup language (HTML) or JavaScript so as to prevent focus movement, thereby ensuring focus movement that meets a user's intention.

That is, when the new attribute, preventing externally caused focus movement, is defined in all elements that enable the focus movement, all external focus movements, which may possibly occur after a user selects an element from among the all elements, are disregarded.

FIG. 2 is a block diagram of a multimedia apparatus for implementing a method of controlling a focus of an application, according to an exemplary embodiment of the present invention.

The multimedia apparatus according to an exemplary embodiment in relation to FIG. 2 includes an input unit 210, a display unit 220, a memory unit 230, a network interface unit 240, and a control unit 250.

The input unit 210 corresponds to a keyboard or a mouse, and includes a plurality of numeral/text input keys and function keys for interfacing with a user. In particular, the input unit 210 generates a user input event.

The display unit 220 displays a web browser or an application generated in the control unit 250, and displays a focus area for indexing an anchor point on the web browser or the application.

The memory unit 230 is formed as a read-only memory (ROM) and a voice memory for storing a plurality of programs and data. In particular, the memory unit 230 stores contents and focus attribute information.

The network interface unit 240 performs bi-directional communication with a web server via wire-wireless networks, and receives HTML contents or JavaScript contents from the web server according to a contents request from the control unit 250.

The control unit 250 performs focus movement caused by the user input event in the web browser, detects predetermined focus attribute information when focus movement caused by contents is requested while the user input event is processed, and determines the focus movement caused by contents according to the focus attribute information. At this time, if the focus attribute information indicates a focus-lock, the control unit 250 disregards the focus movement caused by contents. However, if the focus attribute information indicates a focus-on, the control unit 250 allows the focus movement caused by contents. Here, the control unit 250 extracts the focus attribute information that is predetermined as user setting information of the web browser or a web document.

Also, when the control unit 250 receives a request for the focus movement caused by contents while the user input event is processed, the control unit 250 detects a focus policy predetermined in the user setting information, and determines the focus movement caused by contents according to the focus policy.

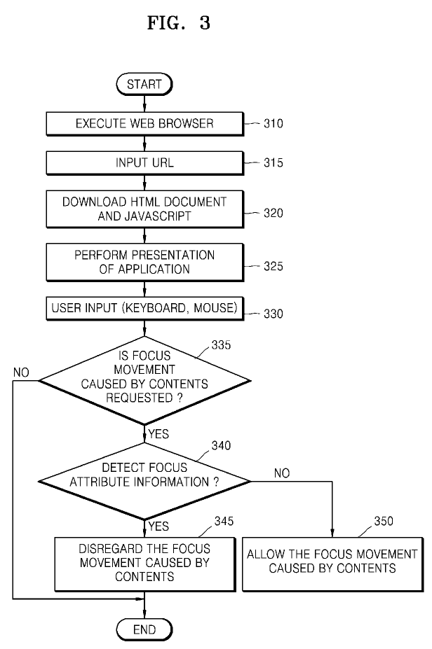

FIG. 3 is a flowchart of a method of controlling a focus of an application, according to an exemplary embodiment of the present invention.

Focus attribute information is predetermined in an HTML specification or JavaScript by a multimedia apparatus manufacturer. Here, the focus attribute information is added to elements (such as <input>, <select>, and the like) that enable focus movement. For example, the focus attribute information may be set as a “focus-lock” that prevents focus movement caused by contents.

First, a multimedia apparatus executes a web browser such as Internet Explorer or an application on a screen, according to a user selection (operation 310).

A Uniform Resource Locator (URL) is input to an address field in the web browser so as to receive contents from a web server (operation 315).

An HTML document and JavaScript existing in the input URL are downloaded (operation 320).

Texts or graphics executed by an application (or contents) are presented to be displayed on the screen, wherein the application (or the contents) is generated by using the HTML document and the JavaScript (operation 325).

A user input event is detected from a user input device, such as a keyboard or a mouse (operation 330).

When the user input event is detected, focus control syntax is extracted by parsing the HTML document or the JavaScript, and whether focus movement caused by contents is requested is determined by referring to the focus control syntax (operation 335).

When it is determined in operation 335 that the focus movement caused by contents is requested, whether a focus-lock is detected is determined by referring to focus attribute information defined in the HTML document or the JavaScript (operation 340).

When the focus attribute information is detected, a focus caused by user input is constantly maintained, and the focus movement caused by contents due to the JavaScript is disregarded (operation 345). At this time, the focus movement caused by contents remains disregarded until a new focus movement event occurs by the user.

In this manner, by applying the focus-lock to a specific element, focus movement caused by user input may have priority (or, control) higher than that of externally caused focus movement.

Also, by preventing compulsory focus movement that disregards a user's intention, a user may not have to repeat focus movement so that user inconvenience is solved.

However, when the focus attribute information is not detected in operation 340, the focus movement caused by contents is allowed (operation 350).

At this time, a scope for controlling the focus is ended when a new focus event occurs by the user. For example, it is assumed that new attribute information indicating a focus-lock is defined in an element A. When a user moves a focus to the element A, the element A turns to a focus-on state, thus, the focus movement caused by contents is disregarded. However, when the user moves the focus to an element B in which a focus-lock is not defined, the focus movement caused by contents is allowed.

When focus movement has to be periodically performed, the scope for controlling the focus may consider both a user's intention and the intention of the manufacturer of contents.

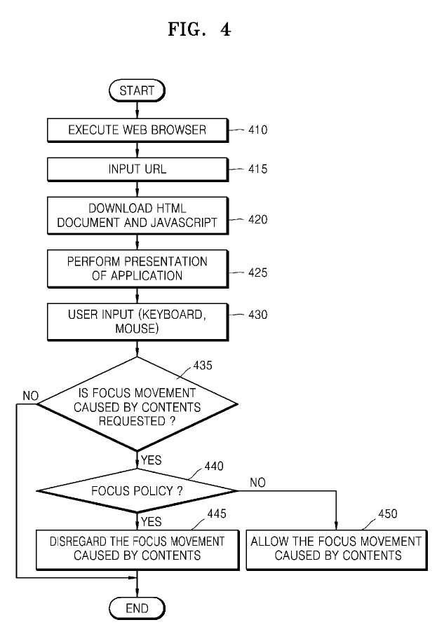

FIG. 4 is a flowchart of a method of controlling a focus of an application, according to another exemplary embodiment of the present invention.

Operations 410 though 435 of the method of FIG. 4 are respectively equal to operations 310 through 335 of the method of FIG. 3, and thus, a description thereof will be omitted here.

When it is determined in operation 435 that focus movement caused by contents is requested, whether a focus policy preventing focus movement is set in a web browser is determined (operation 440).

Here, the focus policy is a priority order between focus movement caused by user input and the focus movement caused by contents, and is added to user setting information of the web browser. For example, the focus movement caused by user input may be set to precede the focus movement caused by contents.

After that, whether a focus policy preventing the focus movement caused by contents exists in the user setting information is determined (operation 440).

When it is determined in operation 440 that a user-set focus policy exists in the user setting information, the focus movement caused by user input is constantly maintained, and the focus movement caused by contents is disregarded (operation 445).

However, when it is determined in operation 440 that the user-set focus policy does not exist in the user setting information, the focus movement caused by contents is allowed (operation 450).

Thus, an additional user scenario may be generated by using a focus policy in a Windows-type application.

The present invention can also be embodied as computer readable codes on a computer readable recording medium. The computer readable recording medium is any data storage device that can store data that can be thereafter read by a computer system. Examples of the computer readable recording medium include read-only memory (ROM), random-access memory (RAM), CD-ROMs, magnetic tapes, floppy disks, and optical data storage devices.

Alternatively, the present invention can be embodied as computer readable codes on a computer readable recording medium, the computer readable recording medium being carrier waves (such as data transmission through the Internet). The computer readable recording medium can also be distributed over network coupled computer systems so that the computer readable code is stored and executed in a distributed fashion.

While this invention has been particularly shown and described with reference to exemplary embodiments thereof, it will be understood by one of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling a focus of an application, the method comprising:
performing focus movement in response to a user input event in the application;
detecting focus attribute information when contents-requested focus movement is requested while the user input event is processed; and
determining the contents-requested focus movement according to the focus attribute information.

2. The method of claim 1, wherein the application is a web browser.

3. The method of claim 1, wherein the detecting of the focus attribute information comprises:
parsing a hypertext markup language (HTML) document or JavaScript when the user input event is detected, and extracting focus control syntax;
referring to the focus control syntax, and determining whether the contents-requested focus movement is requested; and
when the contents-requested focus movement is requested, referring to attribute information defined in the HTML document or the JavaScript, and detecting a focus-lock.

4. The method of claim 1, wherein the focus attribute information is defined as a hypertext markup language (HTML) document.

5. The method of claim 1, wherein the focus attribute information is defined as a JavaScript document.

6. The method of claim 1, wherein the focus attribute information comprises focus-lock information used to prevent focus movement.

7. The method of claim 1, wherein the focus attribute information comprises a focus policy by which the application prevents focus movement.

8. The method of claim 7, wherein the focus policy comprises a priority order between focus movement caused by user input and the contents-requested focus movement.

9. The method of claim 1, wherein the focus attribute information is added to an element enabling focus movement.

10. The method of claim 1, wherein the focus attribute information is added to user setting information of the application.

11. The method of claim 1, wherein the determining of the contents-requested focus movement comprises:
when the focus attribute information indicates a focus-lock, disregarding the contents-requested focus movement; and
when the focus attribute information indicates a focus-on, allowing the contents-requested focus movement.

12. The method of claim 1, wherein the determining of the contents-requested focus movement comprises:
when a user-set focus policy exists, disregarding the contents-requested focus movement; and
when the user-set focus policy does not exist, allowing the contents-requested focus movement.

13. The method of claim 11, wherein the contents-requested focus movement is disregarded until a new focus movement event occurs in response to a new user input event.

14. The method of claim 12, wherein the contents-requested focus movement is disregarded until a new focus movement event occurs in response to a new user input event.

15. The method of claim 1, wherein the contents-requested focus movement is disregarded when a focus moves to a specific element in which a focus-lock is defined, and the contents-requested focus movement is allowed when the focus moves to a specific element in which the focus-lock is not defined.

16. An apparatus for controlling a focus, the apparatus comprising:
an input unit generating a user input event;
a display unit displaying a focus area on a web browser; and
a control unit performing focus movement caused by the user input event in the web browser, detecting focus attribute information when focus movement caused by contents is requested while the user input event is processed, and determining the focus movement caused by contents according to the focus attribute information.

17. The apparatus of claim 15, wherein the control unit disregards the focus movement caused by contents when the focus attribute information indicates a focus-lock, and allows the focus movement caused by contents when the focus attribute information indicates a focus-on

18. The apparatus of claim 15, wherein the control unit extracts the focus attribute information that is previously set as user setting information of the web browser or a web document.

19. A computer readable recording medium having recorded thereon a program, which when executed by a computer, the program causes the computer to execute a method of controlling a focus of an application, the method comprising:
performing focus movement in response to a user input event in the application;
detecting focus attribute information when contents-requested focus movement is requested while the user input event is processed; and
determining the contents-requested focus movement according to the focus attribute information.
